(19) United States
(12) Patent Application Publication
(10) Pub. No.: US 2020/0134731 A1
(43) Pub. Date: Apr. 30, 2020

(54) SYSTEM AND METHOD FOR BACKDATED TRANSACTION PROCESSING WITH WIND BACK SUPPORT

(71) Applicant: Tata Consultancy Services Limited, Mumbai (IN)

(72) Inventor: Sanchari MUKHERJEE MALLICK, Kolkata (IN)

(73) Assignee: Tata Consultancy Services Limited, Mumbai (IN)

(21) Appl. No.: 16/662,576

(22) Filed: Oct. 24, 2019

(30) Foreign Application Priority Data
Oct. 24, 2018 (IN) 201821040110

(51) Int. Cl. G06Q 40/08

(52) U.S. Cl. CPC G06Q 40/08

(57) ABSTRACT

This disclosure relates generally to a system and method to execute a reversal mechanism over a financial instrument to amend at least one business transaction to its same state as it exists before. Further, the process amends a backdated transaction, a back dated alteration and a death claim which happened in past but claim has been registered in current date in a chronological order of occurrence. It provides a single click on the application to do wind back and wind forward of the business transaction as determined by effective date, priority date, and the business transaction creation date. Moreover, the system allows re-application of the affected rows of the financial instrument again without external support based on an analysis of records of an audit trail.

### PRIORITY CLAIM

This U.S. patent application claims priority under 35 U.S.C. § 119 to Indian Application No. 201821040110, filed on Oct. 24, 2018. The entire contents of the aforementioned application are incorporated herein by reference.

### TECHNICAL FIELD

The disclosure herein generally relates to the field of amending one or more business transactions of a financial instrument, and, more particularly, a method to execute a reversal mechanism over a financial instrument to amend a business transaction which results to a same state as existed before.

### BACKGROUND

A business transaction is a logical unit of processing which can be executed on a financial instrument in an order as determined by effective date, priority and transaction creation date. The business transaction can only be executed once calendar date reaches the transaction effective date. However, the date created by a transaction may not be same as the transaction effective date. Sometime, management decides that some transactions would get applied before some other if they have the same effective date. Thus, priority is also an order in which a transaction will execute in case there are multiple transactions for the same policy on the same effective date.

A transaction wind-back support has been arisen to increase or decrease insurance premium from a date which is few months back from current date. To implement this kind of request, the premium due amounts need to be changed from that back date and all kind of re-calculations, related to premiums, are needed to be done. Hence, it is required to have an arrangement which can execute a reversal mechanism over an identified business transaction.

### SUMMARY

Embodiments of the present disclosure present technological improvements as solutions to one or more of the above-mentioned technical problems recognized by the inventors in conventional systems. For example, in one embodiment, a method to execute a reversal mechanism over a financial instrument to amend a business transaction which results to a same state as existed before is provided. In another embodiment, a system configured to execute a reversal mechanism over a financial instrument to amend a business transaction which results to a same state as existed before is provided.

The method includes one or more steps of receiving at least one request from a user to amend at least one business transaction corresponding to at least one financial instrument associated with the user, validating the received at least one request of the user based on the business rules, invoking a transaction framework to identify at least one completed business transaction, wherein the completed business transaction is queued in an order of priority date. Further, at least an audit trail of the completed business transaction is invoked to analyze a chronological order of occurrence of the completed transaction, wherein the chronological order comprises of one or more transactions depend on the business transaction. Finally, a reversal mechanism is applied over the identified at least one completed business transaction to reverse the completed transaction to a same state as it existed earlier in the chronological order of occurrence. It would be appreciated that the reversal mechanism comprise of a wind back and wind forward process. Moreover, the reversal mechanism of at least one business transaction includes executing a backdated transaction, a backdated alteration, and a wrong business transaction entry. Further herein, the at least one request from the user to amend the at least one business transaction comprise of at least a range of date and at least a range of amount to be amended in the at least one financial instrument.

The system is comprising at least one memory which is storing a plurality of instructions and one or more hardware processors communicatively coupled with the at least one memory. The one or more hardware processors are configured by the plurality of instructions to execute one or more modules of the system. The system comprises a receiving module to receive at least one request from a user to amend at least one business transaction corresponding to at least one financial instrument associated with the user. A validation module is configured to validate the received at least one request of the user based on the one or more predefined business rules. An invocation module is configured to invoke a transaction framework to identify at least one completed business transaction, wherein the completed business transaction is queued in an order of priority date. An analyzing module is configured to analyze an audit trail of the completed business transaction to learn a chronological order of occurrence of the completed transaction. Wherein the chronological order of occurrence of the completed transaction comprises of one or more entries in the financial instrument which are depend on the business transaction. Finally, a reversal module of the system is configured to apply a reversal mechanism over the identified at least one completed business transaction to reverse the completed transaction to a same state as it existed earlier in the chronological order of occurrence. It would be appreciated that the reversal mechanism comprise of a wind back and wind forward process. Moreover, the reversal mechanism of at least one business transaction includes executing a backdated transaction, a backdated alteration, and a wrong business transaction entry. Further herein, the at least one request from the user to amend the at least one business transaction comprise of at least a range of date and at least a range of amount to be amended in the at least one financial instrument.

In yet another embodiment, one or more non-transitory machine readable information storage mediums comprising one or more instructions is provided. The one or more instructions when executed by one or more hardware processors causes the one or more hardware processors to perform a method for validating, via one or more hardware processors, the received at least one request from the user based on one or more predefined business rules; invoking, via one or more hardware processors, a transaction framework to identify at least one completed business transaction, wherein the completed business transaction is queued in an order of priority date; analyzing, via one or more hardware processors, at least an audit trail of the completed business transaction to learn a chronological order of occurrence of the completed transaction, wherein the chronological order comprises of one or more transactions depend on the business transaction; and applying, via one or more hardware processors, a reversal mechanism over the identified at least one completed business transaction to reverse the completed transaction to a same state as it existed earlier in the chronological order of occurrence, wherein the reversal mechanism comprise of a wind back and wind forward process.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a functional block diagram of a system (device) for executing a reversal mechanism over at least one financial instrument to amend at least one business transaction of the respective financial instrument, according to some embodiments of the present disclosure.

FIG. 2 illustrates an exemplary flow diagram of a processor implemented method for executing a reversal mechanism over at least one completed business transaction to reverse the completed transaction to a same state as it existed earlier in a chronological order of occurrence, in accordance with some embodiments of the present disclosure.

It should be appreciated by those skilled in the art that any block diagrams herein represent conceptual views of illustrative systems and devices embodying the principles of the present subject matter. Similarly, it will be appreciated that any flow charts, flow diagrams, and the like represent various processes which may be substantially represented in computer readable medium and so executed by a computer or processor, whether or not such computer or processor is explicitly shown.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

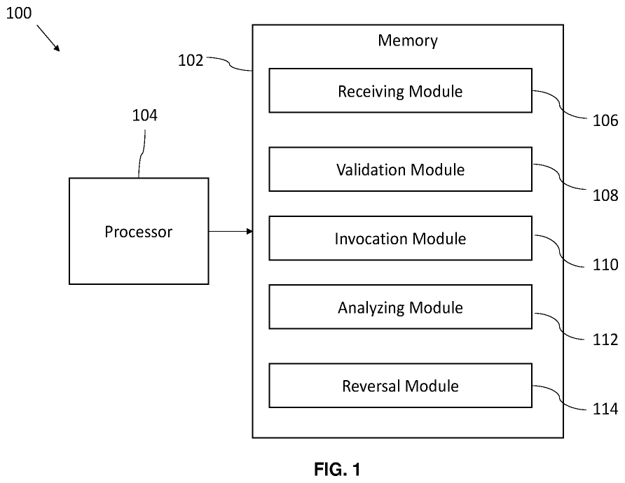

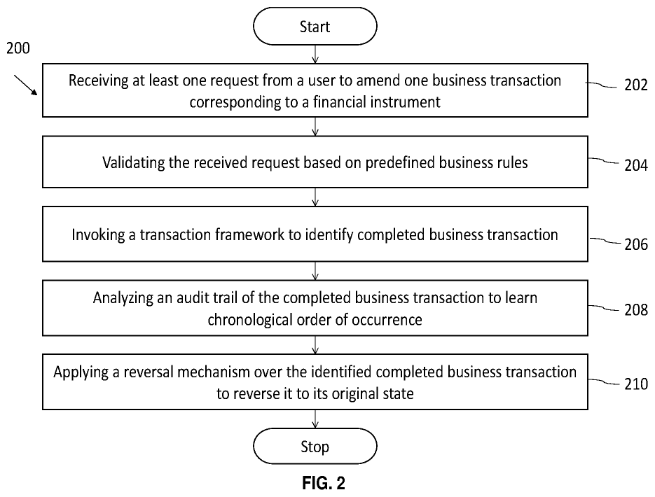

Referring now to the drawings, and more particularly to FIG. 1 through FIG. 2, where similar reference characters denote corresponding features consistently throughout the figures, there are shown preferred embodiments and these embodiments are described in the context of the following exemplary system and/or method.

Referring FIG. 1, illustrating a system (100) which is configured to execute a reversal mechanism over at least one financial instrument to amend at least one business transaction of the respective financial instrument. The system comprises at least one memory (102) and one or more hardware processors (104). The at least one memory (102) of the system (100) includes a plurality of instructions. The one or more hardware processors (104) are communicatively coupled with the at least one memory (102) of the system (100) to execute a plurality of modules of the system (100). It would be appreciated that the amendment results the business transaction to a same state as existed before. It provides a single click on an application to do either a wind back or wind forward. Moreover, the at least one business transaction reverses in a chronological order of occurrence up to the immediate done transaction after the first pending transaction or a done transaction in case a done transaction is marked for deletion. It is to be noted that during reversal, if any business transaction is marked as non-wind back-able, then that particular transaction would be completely ignored and will not be reversed. Further herein, there may be a reversal stop date in the identified financial instrument at a policy level and no reversal is permitted once the stop date is reached. Usually, migration date of a financial instrument is marked as a stop date.

It would be appreciated that there are three stages to execute a business transaction such as a first time execution of the business transaction, a reversal of an executed business transaction and a re-application of the same business transaction which is already executed previously. In the first time execution the business transaction is getting applied for the first time. In the reversal of the completed business transaction, the result data of the execution is getting reverted back to a state as existed before commencement of the transaction and contras are being generated accordingly then the business transaction is getting in reversal mode. This reversal is known as wind back. The re-application of the business transaction comes into picture when after a wind back, if the similar transaction is executed again with different inputs then the transaction goes in the re-application mode. The re-application is also termed as ‘wind forward’.

In the preferred embodiment, a receiving module (106) of the system (100) is configured to receive at least one request from a user to amend at least one business transaction corresponding to an at least one financial instrument associated with the user. Herein, the at least one business transaction may comprise a backdated transaction, a backdated alteration, and a death claim which happened in past but claim has been registered in current date.

It is to be noted that the business transaction is a logical unit of processing which can be executed on a financial instrument in an order as determined by an effective date, a priority date and a transaction creation date. The transaction can only be attempted when a calendar date reaches to the effective date. Although, the creation date may not be same as the transaction effective date. For example, a future dated premium transaction can be created so that billing process can look into those.

During a pre-processing of the business transaction, the system may check for all the predefined conditions which, if satisfied, would allow the transaction to be completed. In case any of such validations fails, then the business transaction would termed as a pending. Depending on one or more business rules the business transaction is altered either the effective date or instruction of the business transaction or cancel a completed business transaction or update its own effective date as per the at least one request from the user.

Further herein, it would be appreciated that a particular business transaction may get applied before some other business transaction even if they have the same effective date due to one or more predefined business rules of the product. For example, in a term product, herein as a financial instrument, both re-instatement and lapse would run with a transaction effective date same as first unpaid payment (FUP). But the re-instatement should have a lower priority otherwise the financial instrument would be lapsed after the re-instatement. Thus, the priority is an order in which the transaction will execute in case there are multiple business transactions for the same financial instrument on the same effective state. This is specific characteristic of each company and the product.

In the preferred embodiment, a validation module (108) of the system (100) is configured to validate the received at least one request from the user based on one or more predefined business rules. It would be appreciated that the validation of the at least one request is an important feature which need to be validated before executing the reversal mechanism over the financial instruments. If there is any failure due to any business rule or technical exception that may render the at least one request failed.

In the preferred embodiment, an invocation module (110) of the system (100) is configured to invoke a transaction framework for identifying at least one completed business transaction. It is to be noted that if in a financial instrument more than one business transaction is done then each completed business transaction is queued up in an order of priority date. It would be appreciated that a business transaction may have different transaction stages such as draft, pending, completed, running, reversed, deleted, paused, and failed. Though, only completed transaction can be reversed not earlier than this stage. For example, if a transaction is created but the business is not approving the execution before a certain event then the transaction is at a draft stage. The draft stage of the transaction would be ignored during applying reversal mechanism due to a draft transaction.

In the preferred embodiment, an analyzing module (112) of the system (100) is configured to analyze an audit trail of the completed business transaction to learn a chronological order of occurrence of the completed transaction, wherein the chronological order comprises of one or more transactions depend on the business transaction.

In the preferred embodiment, a reversal module (114) of the system (100) is configured to apply a reversal mechanism over the at least one financial instrument to amend the identified at least one business transaction. Herein, the amendment of the at least one business transaction would be either a wind back transaction or a wind forward transaction. Further herein, the amendment changes the at least one business transaction to a previous state as it existed earlier. It would be appreciated that each business transaction has an effective date and a priority.

Referring FIG. 2, illustrating a computer implemented method (200) to execute a reversal mechanism over at least one completed business transaction to reverse the completed transaction to a same state as it existed earlier in a chronological order of occurrence. It provides a single click on an application to do either a wind back or wind forward. Moreover, the at least one business transaction reverses in a chronological order of occurrence up to the immediate done transaction after the first pending transaction or a done transaction in case a done transaction is marked for deletion. It is to be noted that during reversal, if any business transaction is marked as non-wind back-able, then that particular transaction would be completely ignored and will not be reversed. Further herein, there may be a reversal stop date in the identified financial instrument at a policy level and no reversal is permitted once the stop date is reached. Usually, migration date of a financial instrument is marked as a stop date.

Initially, at step (202), at least one received is received from a user at a receiving module (106) of the system (100) to amend at least one business transaction corresponding to an at least one financial instrument associated with the user. Herein, the at least one business transaction may comprise a backdated transaction, a backdated alteration, and a death claim which happened in the past, but a claim has been registered in current date.

In the preferred embodiment, at the next step (204), the received at least one request from the user is validated at a validation module (108) of the system (100) based on one or more predefined business rules. It would be appreciated that the validation of the at least one request is an important feature which need to be validated before executing the reversal mechanism over the financial instruments. If there is any failure due to any business rule or technical exception that may render the at least one request failed.

In the next step at (206), a transaction framework is invoked at an invocation module (110) of the system (100) to identify at least one completed business transaction.

In the next step (208), an audit trail of the completed business transaction is analyzed at an analyzing module (112) of the system (100) to learn a chronological order of occurrence of the completed transaction, wherein the chronological order comprises of one or more transactions depend on the business transaction.

At the final step (210), a reversal mechanism is applied over the at least one financial instrument to amend the identified at least one business transaction using a reversal module (114) of the system (100). In the preferred embodiment, the amendment of the at least one business transaction would be either a wind back transaction or a wind forward transaction. Herein, the amendment changes the at least one business transaction to a previous state as it existed earlier. It would be appreciated that each business transaction has an effective date and a priority.

It would be appreciated that if the business transaction reversal due to a back dated transaction creation or update, then the one or more entries of the financial instrument would reversed and a new pending transaction would be generated in lieu of the reversed business transaction with same creation sequence, priority and effective date. Moreover, if the business transaction reversal is due to delete of a completed business transaction, then after reversal no pending entries would be created in lieu of the reversed transaction.

In an example, where a business transaction framework is designed as an even driven asynchronous processing engine that triggers action on a financial instrument using one or more instructions asynchronously passed by the business process and is capable of performing automatic wind back for back dated transaction. For every successful business transaction a new version of data is created and on wind-back pre-image of data is restored. It would be appreciated that every business transaction have associated priorities defined based on business requirements such as charges to be applied only after all units are allocated. The transaction framework can sequence transaction by effective date, priority and creation order. Further, the transaction framework also supports a recurring transaction via an automated creation of future dated pending transaction, a pre-application of future dated transactions to support real world processes like premium/contribution collection or payouts, and transaction queuing for external dependencies like availability of fund prices.

In another embodiment, wherein if the reversal is due to a back-dated transaction creation or update, then for all the business transactions being reversed and a new pending transaction is generated in lieu of the reversed transaction with same creation sequence, priority and effective date. Further, if the reversal is due to delete of a done business transaction, then after reversal no pending transaction is created in lieu of the reversed transaction. It is to be noted that if the parent business transaction is reversed, the child business transaction would be deleted.

It would be appreciated that wherein the at least one business transaction comprises an effective date and a priority date, therein a predefined incremental running sequence is used to execute the reversal mechanism.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

Embodiments of the present disclosure herein address an unresolved problem of reversal of a business transaction of a financial instrument. Such embodiments thus provide a system and method to execute a reversal mechanism over at least one financial instrument to amend at least one business transaction. Moreover, the embodiments herein further provide a single click on an application to rectify a backdated transaction and to execute a backdated alteration and a death claim which happed in the past, but a claim has been registered in current date. As a result, the date would be reversed and returned to a same state as existed before. It would be appreciated that whenever transactions has been executed the system always keep an audit trail in all the subsequent database tables and when reversal of transactions has happened at that time the user may find the audit trails of all the affected trails and goes for re-apply the affected rows once again without any manual intervention.

It is to be understood that the scope of the protection is extended to such a program and in addition to a computer-readable means having a message therein; such computer-readable storage means contain program-code means for implementation of one or more steps of the method, when the program runs on a server or mobile device or any suitable programmable device. The hardware device can be any kind of device which can be programmed including e.g. any kind of computer like a server or a personal computer, or the like, or any combination thereof. The device may also include means which could be e.g. hardware means like e.g. an application-specific integrated circuit (ASIC), a field-programmable gate array (FPGA), or a combination of hardware and software means, e.g. an ASIC and an FPGA, or at least one microprocessor and at least one memory with software modules located therein. Thus, the means can include both hardware means and software means. The method embodiments described herein could be implemented in hardware and software. The device may also include software means. Alternatively, the embodiments may be implemented on different hardware devices, e.g. using a plurality of CPUs.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A system comprising:
at least one memory storing instructions;
one or more hardware processors communicatively coupled with the memory, wherein the one or more hardware processors are configured by the instructions to execute a method comprising:
receiving at least one request from a user to amend at least one business transaction corresponding to at least one financial instrument of the user, wherein the business transaction is a logical unit of processing which can be executed on the at least one financial instrument in a defined order as determined by an effective date, a priority date and a transaction creation date;
validating the received at least one request from the user based on one or more predefined business rules;
invoking a transaction framework to identify at least one completed business transaction, wherein the completed business transaction is queued in an order of priority date;
invoking and analyzing at least an audit trail of the completed business transaction to analyze a chronological order of occurrence of the completed transaction, wherein the chronological order comprises one or more transactions depend on the business transaction; and
applying a reversal mechanism over the identified at least one completed business transaction to reverse the completed transaction to a same state as it existed earlier in the chronological order of occurrence, wherein the reversal mechanism comprises a wind back and wind forward process.

2. The system as claimed in claim 1, wherein the at least one request from the user to amend the at least one business transaction comprise of at least a range of date and at least a range of amount to be amended in the at least one financial instrument.

3. The system as claimed in claim 1, wherein the reversal mechanism of at least one business transaction includes executing a backdated transaction, a backdated alteration, and a wrong business transaction entry.

4. The system as claimed in claim 1, wherein the reversal of at least one business transaction results into reversal to a same state as existed earlier.

5. The system as claimed in claim 1, wherein the at least one business transaction comprises an effective date and a priority date, and wherein a predefined incremental running sequence is used to execute the reversal mechanism.

6. A processor-implemented method comprising:
receiving, via one or more hardware processors, at least one request from a user to amend at least one business transaction corresponding to at least one financial instrument of the user, wherein the business transaction is a logical unit of processing which can be executed on the at least one financial instrument in a defined order as determined by an effective date, a priority date and a transaction creation date;
validating, via the one or more hardware processors, the received at least one request from the user based on one or more predefined business rules;
invoking, via the one or more hardware processors, a transaction framework to identify at least one completed business transaction, wherein the completed business transaction is queued in an order of priority date;
analyzing, via the one or more hardware processors, at least an audit trail of the completed business transaction to learn a chronological order of occurrence of the completed transaction, wherein the chronological order comprises one or more transactions depend on the business transaction; and
applying, via the one or more hardware processors, a reversal mechanism over the identified at least one completed business transaction to reverse the completed transaction to a same state as it existed earlier in the chronological order of occurrence, wherein the reversal mechanism comprises a wind back and wind forward process.

7. The method as claimed in claim 6, wherein the at least one request from the user to amend the at least one business transaction comprise of at least a range of date and at least a range of amount to be amended in the at least one financial instrument.

8. The method as claimed in claim 6, wherein the reversal mechanism of at least one business transaction includes executing a backdated transaction, a backdated alteration, and a wrong business transaction entry.

9. The method as claimed in claim 6, wherein the reversal of at least one business transaction results into reversal to a same state as existed earlier.

10. The method as claimed in claim 6, wherein the at least one business transaction comprises an effective date and a priority date, and wherein a predefined incremental running sequence is used to execute the reversal mechanism.

11. A non-transitory computer readable medium having a computer readable program embodied therein, wherein the computer readable program, when executed on a computing device, causes the computing device to:
receive, via one or more hardware processors, at least one request from a user to amend at least one business transaction corresponding to at least one financial instrument of the user, wherein the business transaction is a logical unit of processing which can be executed on the at least one financial instrument in a defined order as determined by an effective date, a priority date and a transaction creation date;
validate, via the one or more hardware processors, the received at least one request from the user based on one or more predefined business rules;
invoke, via the one or more hardware processors, a transaction framework to identify at least one completed business transaction, wherein the completed business transaction is queued in an order of priority date;
analyze, via the one or more hardware processors, at least an audit trail of the completed business transaction to learn a chronological order of occurrence of the completed transaction, wherein the chronological order comprises one or more transactions depend on the business transaction;
apply, via the one or more hardware processors, a reversal mechanism over the identified at least one completed business transaction to reverse the completed transaction to a same state as it existed earlier in the chronological order of occurrence, wherein the reversal mechanism comprises a wind back and wind forward process.
